(19) United States
(12) Patent Application Publication
(10) Pub. No.: US 2015/0055242 A1
(43) Pub. Date: Feb. 26, 2015

(54) METHOD AND SYSTEM FOR ESTIMATING THE POSITION ERROR SIGNAL (PES) METRIC FOR A MAGNETIC STORAGE SYSTEM

(71) Applicant: AGENCY FOR SCIENCE, TECHNOLOGY AND RESEARCH, Singapore (SG)

(72) Inventors: Moulay Rachid ELIDRISSI, Singapore (SG); Kheong Sann CHAN, Singapore (SG); Zhimin YUAN, Singapore (SG)

(73) Assignee: AGENCY FOR SCIENCE, TECHNOLOGY AND RESEARCH, Singapore (SG)

(21) Appl. No.: 14/464,538

(22) Filed: Aug. 20, 2014

(30) Foreign Application Priority Data
Aug. 20, 2013 (SG) SG201306329-2

(51) Int. Cl. G11B 20/10; G11B 5/09

(52) U.S. Cl. CPC G11B 20/10212; G11B 5/09
USPC 360/65

(57) ABSTRACT

A method and system for estimating the position error signal (PES) metric for a magnetic storage system. The method comprises the steps of reading multiple readback tracks from a storage medium of the magnetic storage system using respective readers of a multiple reader head positioned at or near a data track of interest; employing an adaptive SMR equalizer to equalize the signals from the multiple read head; and extracting information from the adaptive SMR equalizer sub-filters as an estimate of the PES metric.

This application makes reference to and claims the benefit of priority of the application for “Continuous Position Error Signal Obtained from Data Track with A 2/3 Reader Head in Shingled Magnetic Recording” filed on Aug. 20, 2013, with the Intellectual Property Office of Singapore, and there duly assigned application number 201306329-2. The content of said application filed on Aug. 20, 2013 is incorporated herein by reference for all purposes, including an incorporation of any element or part of the description, claims or drawings not contained herein.

### FIELD OF THE INVENTIONS

The present invention relates to method and system for estimating the position error signal (PES) metric for a magnetic storage system

### BACKGROUND OF THE INVENTIONS

The Servo Position Error Signal (PES) in commercial drives is obtained from information stored in servo wedges and typically takes up about 3 to 4% of the disk surface. In the conventional servo system, between servo wedges, the head writes and reads data tracks without servo positioning control. For a given track pitch, the amount of vibrations that can be tolerated is limited. Shingled magnetic recording (SMR) technology has been proposed to extend the life of perpendicular magnetic recording (PMR). In SMR, narrow data tracks are written with a wide writer by successively overlapping adjacent tracks. SMR currently uses one-dimensional (1D) readback which can be obtained with a conventional single reader head. As the track density increases, Inter-Track Interference (ITI) arises due to the reader picking up magnetic signal from the adjacent track and is typically cancelled by using readbacks on adjacent tracks.

Conventional channel detectors, such as detectors using the Viterbi algorithm, require the bit response of the channel to be equalized to a short length partial response. The conventional partial response equalizer corresponds to a 1D finite impulse response (FIR) digital filter that shortens the target to a known predefined shape. With the generalized partial response (GPR) equalizer, the target filter and equalizer filter are jointly designed in order to minimize the mean squared error (MSE) between the equalized readback signal and the desired ideal signal. Time-varying changes in the channel can occur due to mechanical vibrations, fly height variations, motor jitter, temperature variations etc. . . . . Mechanical vibrations in hard-disk drives result in the head to drift away from the track center. In order for the GPR equalizer to adjust to the changes in the channel, an adaptive algorithm may adapt the equalizer and target filters to track these changes.

Embodiments of the present invention provide a method and a system for estimating the position error signal (PES) metric for a magnetic storage system. This position information can be used by the servo-control loop to place the head at the desired location.

### SUMMARY

In accordance with a first aspect of the present invention, there is provided a method of estimating the position error signal (PES) metric for a magnetic storage system, the method comprising the steps of reading multiple readback tracks from a storage medium of the magnetic storage system using respective readers of a multiple reader head positioned at or near a data track of interest; employing an adaptive SMR equalizer to equalize the signals from the multiple read head; and extracting information from the adaptive SMR equalizer sub-filters as an estimate of the PES metric.

In accordance with a second aspect of the present invention, there is provided a system for estimating the position error signal (PES) metric for a magnetic storage system, the system comprising a multiple reader head configured to be positioned at or near a data track of interest for reading multiple readback tracks from a storage medium of the magnetic storage system using respective readers of the multiple reader head; an adaptive SMR equalizer configured to equalize the signals from the multiple reader head; and a processor unit for extracting information from the adaptive SMR equalizer sub-filters as an estimate of the PES metric.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows the y-component of the write-field used in the micromagnetics simulations employed in the example embodiments.

FIG. 2 illustrates the output of a sample micromagnetic simulation of writing using the write-field depicted in FIG. 1.

FIG. 3 depicts the simulated read-head sensitivity profile of the 30 nm wide reader.

FIG. 4 shows the single/double/triple reader configurations simulated.

FIG. 5 is a block diagram of the non-adaptive SMR equalizer implemented in the sample simulations employed in an example embodiment.

FIG. 6 shows the single-sided 747 bit error rate contours (−1 to −4 in log 10 scale) for single/double/triple reader configurations, when RP=14 nm and RW=30 nm obtained through the simulations employed in the example embodiment.

FIG. 7 shows the energies of the 3 sub-filters designed under the condition that there is no cross-track drift, as a function of the reader offset, obtained through the simulations employed in the example embodiment.

FIG. 8 shows the proposed PES profiles as a function of the reader offset, according to an example embodiment.

FIG. 9 is a block diagram of the adaptive SMR equalizer in training mode, according to an example embodiment.

FIG. 10 shows the estimated RO vs. the introduced sinusoidal RO with 5 nm amplitude and 1 kHz frequency, according to an example embodiment.

FIG. 11 shows the PES estimated from the adaptive equalizer filters as a function of time when the reader is starting at an offset of −10 nm and drifting linearly a cross-track distance of 10 nm, according to an example embodiment.

FIG. 12 shows a flowchart illustrating a method of estimating the PES metric for a magnetic storage system, according to an example embodiment.

FIG. 13 shows a schematic drawings illustrating a system 1300 for estimating the PES metric for a magnetic storage system.

### DETAILED DESCRIPTION OF THE INVENTIONS

Example embodiments described herein seek to make PES information available between servo wedges or to remove the necessity for servo wedges altogether, for preferably making the read/write head positioning more accurate, and enabling reading of narrower tracks without sacrificing the error rate performance, such that higher areal density can be achieved. In example embodiments, a method for obtaining a PES measure based on the retrieved data track rather than PES based on information in servo wedges is provided.

A generalized partial response (GPR) equalizer that uses a 2-dimensional (2D) readback signal is used in an example embodiment for producing a 1-dimensional (1D) equalized readback signal for detecting a single track of interest. In an example embodiment, the equalizer coefficients are used to determine the cross-track position equivalent of the PES in conventional servo systems, also referred to as a “PES measure” herein. The equalizer subfilter shapes change with cross-track position, and a method to extract cross-track position information from the equalizer coefficients is provided in an example embodiment.

In one embodiment, cross-track position information is extracted from the 2D SMR equalizer coefficients as a PES measure. It is noted that there are many possible methods to extract this cross-track position information in different embodiments. In one non-limiting example embodiment, continuous PES-type information can be obtained from a multiple reader head and an adaptive SMR equalizer as follows:
1. Use a multiple reader head to read multiple readback tracks
2. Operate the adaptive SMR equalizer in one of two modes: training mode and tracking mode, which may also be referred to as data-aided mode and non-data-aided mode respectively
   a. In training mode, the data bits are known. The bits and readback waveforms are used to train the adaptive filters (allow them to come close to their appropriate values). Training and tracking modes are also applicable in the conventional adaptive equalizers and are applied to the adaptive SMR equalizer in a similar fashion in example embodiments.
   b. In tracking mode, the data bits are not known and must be detected before they can be used. The data bits are used to update the adaptive equalizer. These data bits for updating the adaptive equalizer are typically obtained with a very simple (short-delay) Viterbi detector. The simplicity of the detector results in a relatively high error rate, but that is good enough to keep the adaptive equalizer coefficients close enough to their appropriate values. For each readback sample:
      i. Detect the bits corresponding to the readback sample received with a short-delay detector
      ii. Update the equalizer and target coefficients (adaptation step)
      iii. Calculate the energies of each equalizer 1D sub-filter (summation of the sub-filter coefficients squared)
      iv. Calculate the baud-rate PES based on the energies of the equalizer 1D sub-filters, PES=(A−B)/(A+B), where A and B are the energies of the appropriate adaptive equalizer subfilters
      v. Downsample the baud-rate PES to a rate that can be used by the servo control loop.

In the following, details of non-limiting example embodiments will be described.

### I. Shingle Block Writing Process

In the simulated embodiment, shingled writing of the data tracks is performed via the grain flipping probability (GFP) model which is a statistical model trained through micromagnetic simulations. Table I lists the constant parameters used during the micromagnetic simulations of this embodiment.

TABLE 1
Constant parameters used in micromagnetics simulations

| MWW (nm) | 91 | Mₛ | 480 | emu/cc |
|---|---|---|---|---|
| Background | AC | σ_{Ms} | 3% | |
| N_{track} | 4 | Kᵤ | 3.6e6 | erg/cc |
| N_{bit} | 1024 | σ_{Ku} | 3% | |
| Bit length (nm) | 15 | Aₓ | 3e−7 | erg/cm |

| | | | |
|---|---|---|---|
| Grain-size (nm) | 6 | σ_{Ax} | 3% |
| Grain pitch (nm) | 7 | easy axis | 0° |
| Grain size σ | 20% | easy axis σ | 1.7° |

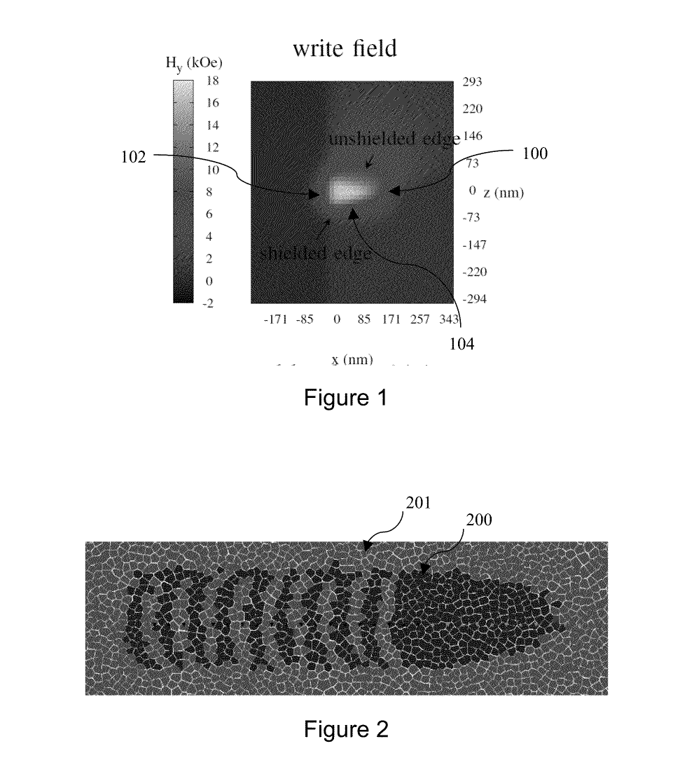

The write-field used in the micromagnetic simulations of this embodiment is that of a triangular pole 100 shielded on two sides 102, 104, as depicted in FIG. 1.

FIG. 2 illustrates the output of a sample micromagnetic simulation, with darker grains e.g. 200 representing positive magnetization and lighter grains e.g. 202 representing negative magnetization.

### II. Reader Configurations

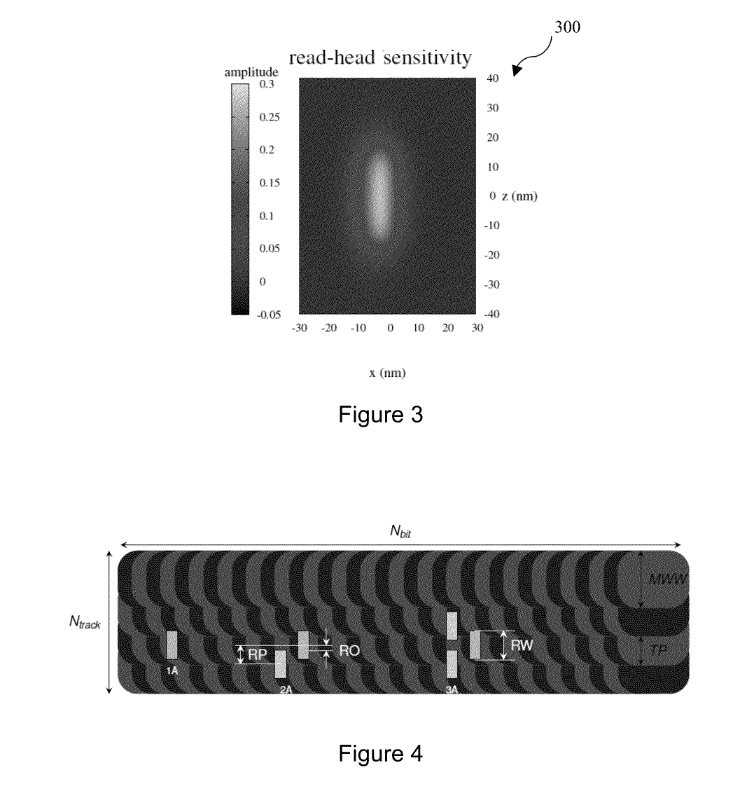

The readback signal is obtained in the example embodiment by convolving the granular magnetization profile (such as shown in FIG. 2) with the read-head sensitivity profile (such as shown in FIG. 3), which is calculated, based on the reciprocity principle and a typical exemplary multi-layer reader structure for use in the simulations.

The reader configurations simulated are single (1A), double (2A) and triple (3A) reader head configurations, as shown in FIG. 4. The reader width (RW) of all readers and the reader pitch are kept constant throughout the simulations of the current embodiment, at 30 nm and 14 nm, respectively. The track pitch (TP) and the off-track reader offset (RO) have been varied.

RP is defined as the cross-track distance between the centers of the free layers of the readers in 2A and 3A configurations.

### III. Non-Adaptive SMR Equalizer

“747” refers to the curves generated that are used to evaluate margins against failure caused by reader mispositioning (soft failure) or squeezing the track of interest beyond recovery (hard failure).

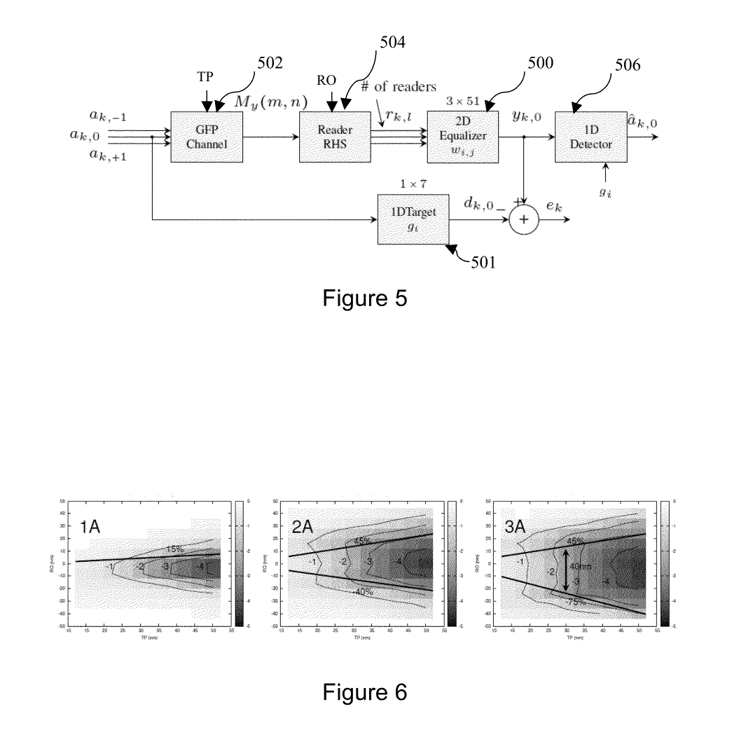

In the simulations, a single-sided “747” test was performed, where the home track is squeezed by an aggressor adjacent track on one side at various levels of squeeze track pitch (TP) and the home track is read back and detected by positioning the single/double or triple reader head at various RO's. In order to perform this test, a non-adaptive SMR equalizer 500 as shown in FIG. 5 was used in an environment with no cross-track drift. The non-adaptive equalizer filter 500 and target coefficients of the SMR equalizer 501 are jointly designed by minimizing the MSE between the equalized readback y_{k,0} and the ideal signal d_{k,0}. The partial response target satisfies the monic constraint g₀=1. The conventional method for solving the equalizer filter and target coefficients was used, which is based on the estimated auto-correlation of the channel bits a_{k,0}, the estimated auto-correlation of the 2D readback r_{k,1} and the estimated cross-correlation between the channel bits and the 2D readback.

It is noted that the term “SMR equalizer” as used herein refers to a 2D FIR (finite impulse response) filter that has multiple (for example three in the example shown in FIG. 3) inputs and produces a single (one) output optimized to a 1D target.

In the example embodiment depicted in FIG. 5, the GFP channel 502 represents the writing path and the Reader RHS block 504 represents the readback path of the magnetic storage system. The signals a_{k,-1}, a_{k,0} and a_{k,1} represent 3 tracks of data being written onto the medium while the readback signals r_{k,1} represent the 3 readback signals coming from respective readers of a triple reader head. It is noted that although the simulations in the sample embodiment are with triple reader heads, the invention is not limited to triple reader heads, but applies to multiple readers with any multiplicity of heads. When the equalizer 500 is static (non-adaptive), the equalizer 500 is designed as described above and the single output y_{k,0} is passed to the 1D detector 506. In a real system there will be cross-track variation during readback depicted by the RO parameter into the RHS block 504. Such cross-track drift results in differences in the statistics of the signals generated, namely in the autocorrelation matrix of r_{k,1} and the cross-correlation matrix between r_{k,1} and a_{k,1}. This in turn leads to the optimum equalizer and target coefficients changing. This is addressed by making the equalizer and target adaptive, as will be described below.

FIG. 6 shows single-sided 747 bit error rate contours (−1 to −4 in log 10 scale) for single/double/triple reader (1A, 2A, and 3A) configurations, i.e. error rate as a function of TP (x-axis) and RO (y-axis), for RP=14 nm and RW=30 nm.

FIG. 6 shows that using a double or triple reader head (2A, 3A) and a corresponding 2D SMR equalizer, the off-track reading capability (OTRC) is significantly improved. In other words, a double/triple reader head used in conjunction with an SMR equalizer can tolerate larger changes in reader offset. This has the benefit of easing the problem that the servo control has to solve. It should be noted that in the simulations of FIG. 6, a static (non-adaptive) equalizer has been designed and there is no cross-track drift injected in the model. When cross-track drift is included into the model, the equalizer is made adaptive to follow that drift, as will be described in detail below.

### IV. PES Estimation Based on SMR Equalizer Coefficients

The non-adaptive SMR equalizer is used to demonstrate the benefit to the OTRC if the cross-track position of the head were not time-varying. In this section, the analysis of PES characterization is illustrated for the triple reader only. A similar analysis can be made with a head holding any multiplicity of readers. It is first noted that the 2D equalizer output of the SMR equalizer 500 shown in FIG. 5 can be written as the sum of 3 1D convolutions as:

y₀=r₁\textcircled{×}w₋₁+r₀\textcircled{×}w₀+r₋₁\textcircled{×}w₁ (1)

where w−1, w0 and w1 are the 3 sub-filters of the 2D SMR equalizer and r₋₁, r₀ and r₁ are the baud-rate readback signals sensed by the bottom, central and top readers, respectively. With this formulation of the 1D equalized readback, it can be seen that each 1D equalizer sub-filter is associated to one reader. One can then view the equalizer sub-filters in a sense as weights applied to each readback signal. For instance, if one of the readers is on-track, then the corresponding sub-filter is expected to have a “larger” weight than the other two. One way of quantifying these weights is to calculate the energies of the sub-filters, which may be calculated as the sum of the squared coefficients of the sub-filter. The energy of the SMR equalizer sub-filters is given by

E_{w}_{ⱼ}=wⱼ^{T}wⱼ

where j=−1, 0 or 1.

In one embodiment, the PES measures can be calculated based on the energies of the 1D sub-filters, as follows:

$$\begin{matrix}PES ( {r}_{0} , {r}_{1} ) = \frac{{E}_{w 0} - {E}_{w 1}}{{E}_{w 0} + {E}_{w 1}} & ( 2 ) \\ PES ( {r}_{- 1} , {r}_{1} ) = \frac{{E}_{w 1} - {E}_{w 1}}{{E}_{w 1} + {E}_{w 1}} & ( 3 ) \\ PES ( {r}_{- 1} , {r}_{0} ) = \frac{{E}_{w 1} - {E}_{w 0}}{{E}_{w 1} + {E}_{w 0}} & ( 4 )\end{matrix}$$

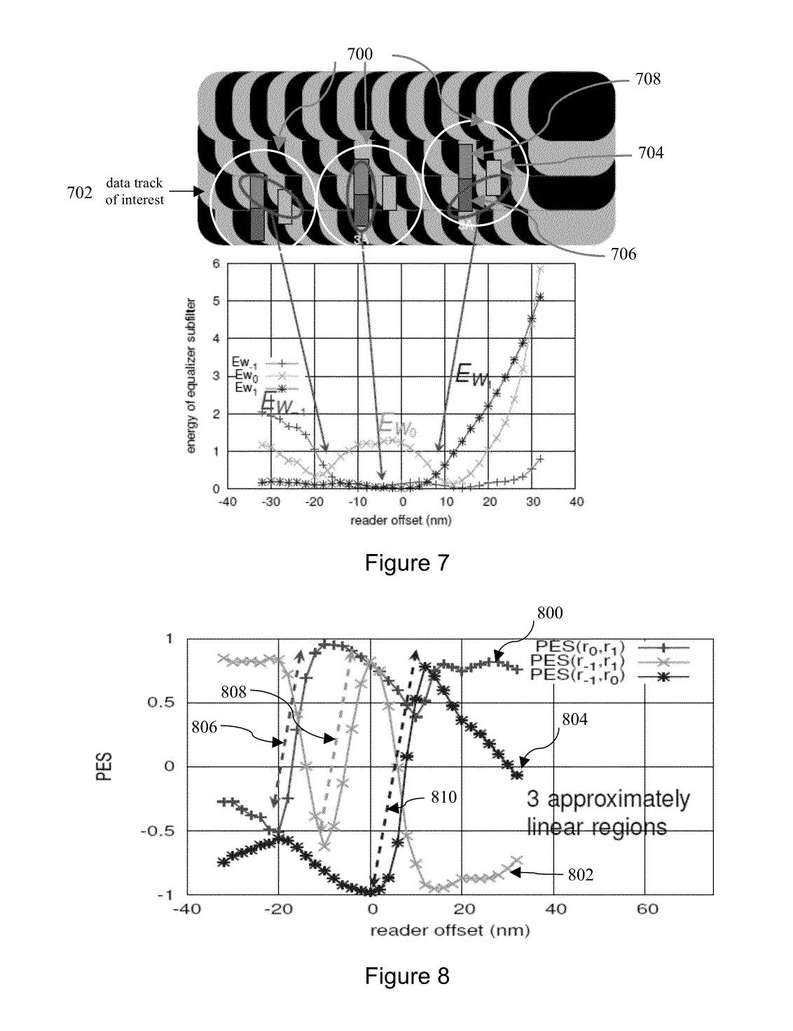

These formulas are further explained with reference to FIG. 7 in which the multiple reader head 700 is depicted positioned in the vicinity of the data track of interest 702. It is noted that the RO values in this simulation are exemplary only. The actual valid range of RO values in a real system will depend on many factors such as the reader width, the reader geometry and the individual reader response functions. FIG. 7 shows that when the center reader 704 is on-track (i.e. RO˜−5 nm), then the energies of the 2 sub-filters associated with the other two readers 706, 708 are approximately equal. Therefore, by taking the difference of the energies E_{w}_{_{−1}} and E_{w}_{₁}, one can get a measure that is
0 when the center reader 700 is on-track,
positive (>0) when the reader structure 700 moves up,
negative (<0) when the reader structure 700 moves down.

The metric is normalized to the sum of the two energies in the current embodiment.

FIG. 8 depicts the transfer curves of the PES measures as a function of RO as determined by (2), (3) and (4) above in one embodiment. Each PES measure 800, 802, 804 exhibits an approximately linear operating range 806, 808, 810 respectively. The linearity of a PES measure is desirable for a servo control loop to operate properly. For example, when the objective is for the reader to stay on-track, then the servo control should be operating in the linear range (−10 nm to 0 nm) of the PES(r−1, r1) transfer curve 802. It should be noted that each linear range is applied over a different RO position range. If the reader is in the −20 to −10 range, then PES(r0,r1) can be used to determine cross-track position. If RO is in the region between −10 and 0 nm, then PES(r−1, r1) can be used and if it is in the 0 to 10 nm region, PES(r−1,r0) can be used. The system will preferably be programmed to handover the responsibility for determining the PES as the reader shifts from one region to the other. Such handover may be implemented, for example, similarly to the PES determination in the conventional ABCD burst used in existing servo systems, where AB bursts are determining one position range and the CD bursts are determining another position range.

The baud-rate PES measure is down-sampled/averaged in the current embodiment, to a rate that is appropriate for the servo control loop. For example, the baud-rate of the channel may be a couple of Gbps and should be downsampled to the rate of the servo control loop that may be several 10's of kHz.

### V. Adaptive SMR Equalizer

With multiple reader heads, the GPR equalizer becomes a 2D FIR filter. In the context of SMR technology with multiple reader heads, we refer to the 2D GPR equalizer as the 2D SMR equalizer, which uses multiple readback signals to equalize the channel response to a short 1D target response. The 2D SMR equalizer can also be made adaptive in order to track changes in the channel. The SMR equalizer tends to have only 2 or 3 taps in the cross-track dimension while quite a few taps in the down-track dimension and it produces a 1D output. Each row in the equalizer's cross-track dimension is equivalent to a 1D subfilter and the SMR equalizer's output is equal to a linear summation of the outputs of these 1D subfilters as denoted in equation (1).

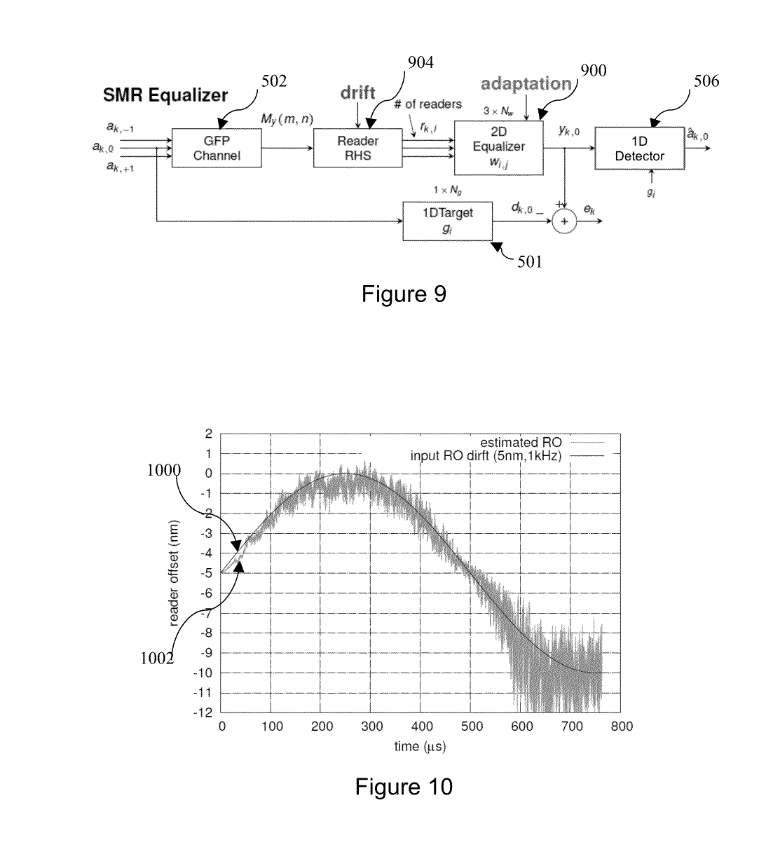

The adaptive SMR equalizer 900 of an example embodiment preferably adapts to changes in the channel such as a time varying reader offset RO(t), as depicted in FIG. 9. The only difference between FIG. 9 and FIG. 5 is that the non-adaptive SMR equalizer 500 has been replaced with an adaptive SMR equalizer 900, in response to the cross-track drift now injected into the model, i.e. at the Reader RHS block 904.

As will be appreciated by a person skilled in the art, the adaptive equalizer uses the data bits to calculate an error signal e(k) that the adaptive filter tries to minimize the power of. The adaptive equalizer can be used in 1 of 2 modes:

1) Training mode
2) Tracking mode

In training mode, the bits for calculating the error signal e(k) are known ahead of time (such as when the reader flies over the known preamble). In tracking mode, the bits for calculating e(k) must be estimated. Implementing the equalizer in training mode is simpler, because one can presume the bits. Implementing the equalizer in tracking mode is a more practical consideration done in the real system, as will be appreciated by the person skilled in the art. Demonstrating that the adaptive equalizer works in training mode is an indication that it will also work with a slight performance degradation in tracking mode, as will be appreciated by the person skilled in the art.

A standard adaptive algorithm, known as the variable step-size least mean square (VSLMS) algorithm, is used in one embodiment to adapt the equalizer filter and target coefficients. The VSLMS update equations are given by

w_{i,j}(k+1)=w_{i,j}(k)−μ_{i,j}^{(w)}(k)e(k)r_{k-i,1-j}

g_{i,0}(k+1)=g_{i,0}(k)+μᵢ^{(g)}(k)e(k)a_{k-i,0}

g_{2,0}(k+1)=1

μ_{i,j}^{(w)}(k+1)=μ_{i,j}^{(w)}(k)+ρ^{(w)}e(k)r_{k-1,1-j}e(k−1)r_{k-1-i,j-1}

μᵢ^{(g)}(k+1)=μᵢ^{(g)}(k)+ρ^{(g)}e(k)a_{k-i,0}(k−1)a_{k-1-i,0},

where w_{i,j} are the adaptive equalizer coefficients and g_{i,k} are the target coefficients being updated, μ_{i,j}^{(w)}(k) and μ_{i,j}^{(g)}(k) are the adaptive step-size parameters for the equalizer and target adaptations respectively, e(k) is the error signal (difference between adaptive filter output and target output) and r_{k-i,1-j} and a_{k-i,0} are the input signals to the adapted equalizer and target filters. While the normal LMS algorithm (without variable step-size) has a constant step size parameter μ_{i,j}^{(w)}(k) and μ_{i,j}^{(g)}(k),the VSLMS algorithm also updates the step sizes to account with its own step size parameters ρ^{(g)} and ρ^{(g)}.

The VSLMS is used as preferably, a larger step size results in improved convergence speed while a smaller step size is used to achieve a smaller mis-adjustment. The VSLMS benefits from the best of both worlds by modifying the step-size parameters appropriately.

### VI. PES Estimation

In this section, two types of reader offset drifts are discussed within the context of the embodiments described by the simulations.

The first type of drift corresponds to a f=1 kHz, 5 nm amplitude sinusoidal drift, given as RO(t)=−5+5 sin(2πft). This type of drift could be due to low frequency mechanical vibrations. With this input drift, it is noted that RO stays in the −10 nm to 0 nm which is the linear range of the center PES transfer curve 802, as seen in FIG. 8. The estimated RO is calculated from the estimated PES(r₋₁,r₁) by reading it off the pre-characterized PES transfer curve 802. FIG. 10 shows the input RO 1000 and the estimated RO 1002.

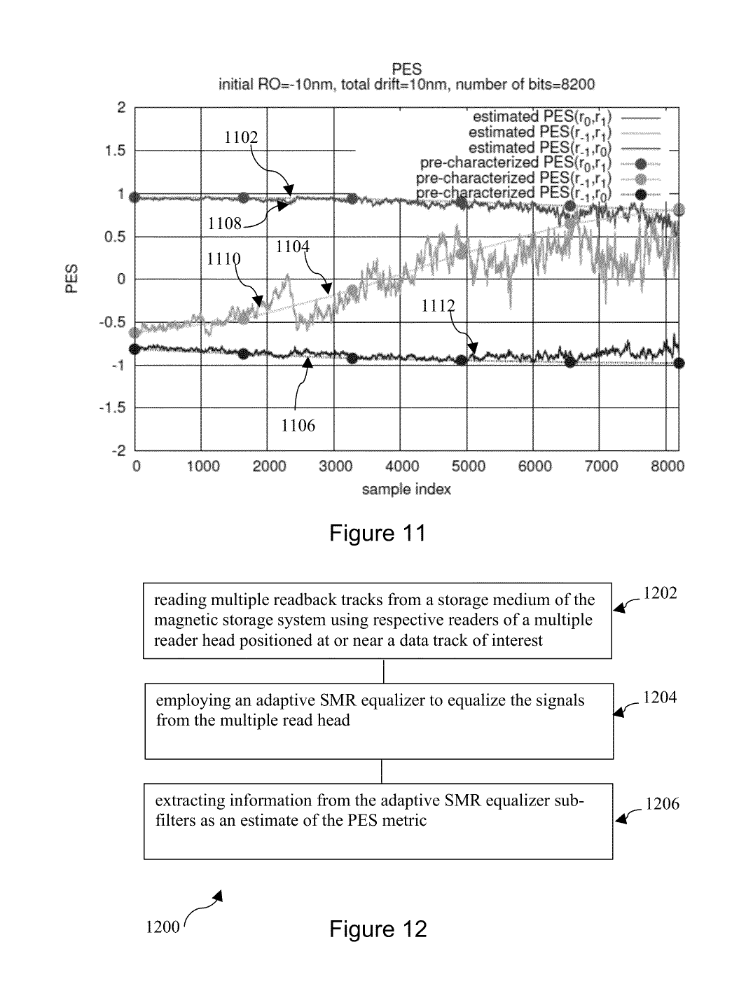

The second type of drift corresponds to an aggressive linear drift of 10 nm during 8 microseconds, i.e. RO(t)=−10+10t/(8.2*10⁻⁶). This type of drift may be due to shocks experienced by the hard disk drive. FIG. 11 shows that estimated PES measures follow the pre-characterized PES measures. FIG. 11 shows the 3 PES metrics computed in equations (2), (3) and (4) changing with time (index) in the presence of the abovementioned shock profile of the reader. The lines 1102, 1104, 1106 with the circles on them denote the ideal PES position as given by passing the RO(t) profile through the PES transfer curves of FIG. 8. The curves 1108, 1110, 1112 without the circles are the PES information calculated via equations (2), (3) and (4) from the adaptive equalizer coefficients and it can be seen that the computed PES information from the adaptive equalizer coefficients does follow the PES metrics generated from the RO(t) profile. This shows that the adaptive equalizer is advantageously able to generate PES information that is able to track the given disturbance profile.

FIG. 12 shows a flowchart 1200 illustrating a method of estimating the position error signal (PES) metric for a magnetic storage system, according to an example embodiment. At step 1202, multiple readback tracks from the storage medium are read using respective readers of a multiple reader head positioned at or near a data track of interest. At step 1204, an adaptive SMR equalizer is employed to equalize the signals from the multiple read head. At step 1206, information from the SMR equalizer sub-filters is extracted as an estimate of the PES metric.

Extracting the information may comprise calculating energies of the respective equalizer sub-filters. Extracting the information may comprise calculating differences in the energies of the respective equalizer sub-filters. Extracting the information may comprise normalizing the calculated differences in the energies of the respective equalizer sub-filters. The normalizing may comprise dividing the calculated differences in the energies of the respective equalizer sub-filters by the sum of the energies as denoted in equations (2), (3) and (4).

The adaptive SMR equalizer may be based on any of a group of adaptive filtering algorithms including, but not limited to the least mean square algorithm (LMS), the variable step-size least mean square (VSLMS) algorithm, the frequency based LMS algorithm, and the partitioned frequency based LMS algorithm.

The method may further comprise using the extracted information for positioning the multiple reader head.

The multiple reader head may comprise any multiplicity of readers mounted on a slider structure.

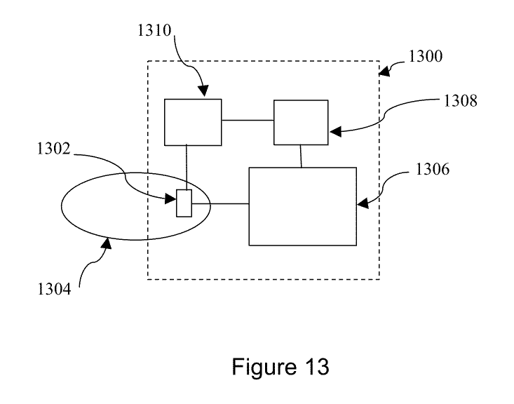

FIG. 13 shows a schematic drawing illustrating a system 1300 for estimating the position error signal (PES) metric for a magnetic storage system. The system 1300 comprises a multiple reader head 1302 configured to be positioned at or near a data track of interest for reading multiple readback tracks from a storage medium 1304 using respective readers of the multiple reader head 1302, an adaptive SMR equalizer 1306 configured to equalize the signals from the multiple reader head 1302, and a processor unit 1308 for extracting information from the adaptive SMR equalizer 1306 sub-filters as an estimate of the PES metric.

The processor unit 1308 may be configured to calculate energies of the respective equalizer sub-filters. The processor 1308 may be configured to calculate differences in the energies of the respective equalizer sub-filters. The processor unit 1308 may be configured to normalize the calculated differences in the energies of the respective equalizer sub-filters. The normalizing may comprise dividing the calculated differences in the energies of the respective equalizer sub-filters by the sum of the energies.

The adaptive SMR equalizer may be based on any of a group of adaptive filtering algorithms including, but not limited to the least mean square algorithm (LMS), the variable step-size least mean square (VSLMS) algorithm, the frequency based LMS algorithm, and the partitioned frequency based LMS algorithm.

The system 1300 may further comprise a servo unit 1310 configured to use the extracted information for positioning the multiple reader head 1302.

The multiple reader head may comprise any multiplicity of readers mounted on a slider structure.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive. Also, the invention includes any combination of features, in particular any combination of features in the patent claims, even if the feature or combination of features is not explicitly specified in the patent claims or the present embodiments

For example, while shingle writing has been described above, it will be appreciated that the present invention is not limited to a particular writing method, but can be applied equally to data written using different writing techniques, such as Perpendicular Magnetic Recording (PMR), microwave assisted magnetic recording (MAMR) or heat assisted magnetic recording (HAMR).

Also, the VSLMS described above is only one example of an adaptive algorithm to use for updating the equalizer coefficients and target coefficients. It will be appreciated that any adaptive algorithm could be used in different embodiments, such as, but not limited to, a normal LMS algorithm, or a frequency based LMS algorithm or a partitioned frequency based LMS algorithm. The VSLMS was chosen in the example embodiments described because of its relative ease of implementation, quick convergence and good misadjustment (i.e. residual error after convergence) properties. As mentioned, the present invention is, however, not limited to using the VSLMS algorithm.

The present specification discloses, inter alia, apparatus for performing the operations of the methods described. Such apparatus may be specially constructed for the required purposes, or may comprise a processor, a general purpose computer or other device selectively activated or reconfigured by a computer program. The algorithms and displays presented herein are not inherently related to any particular computer or other apparatus. Various processors or other device may be used with programs in accordance with the teachings herein. Alternatively, the construction of more specialized apparatus to perform the required method steps may be appropriate.

The invention may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. A method of estimating the position error signal (PES) metric for a magnetic storage system, the method comprising the steps of:
reading multiple readback tracks from a storage medium of the magnetic storage system using respective readers of a multiple reader head positioned at or near a data track of interest;
employing an adaptive SMR equalizer to equalize the signals from the multiple read head; and
extracting information from the adaptive SMR equalizer sub-filters as an estimate of the PES metric.

2. The method as claimed in claim 1, wherein extracting the information comprises calculating energies of the respective equalizer sub-filters.

3. The method as claimed in claim 2, further comprising calculating differences in the energies of the respective equalizer sub-filters.

4. The method as claimed in claim 3, further comprising normalizing the calculated differences in the energies of the respective equalizer sub-filters.

5. The method as claimed in claim 4, wherein the normalizing comprises dividing the calculated differences in the energies of the respective equalizer sub-filters by the sum of the energies.

6. The method as claimed in claim 1, wherein the adaptive SMR equalizer is based on any of a group of adaptive filtering algorithms including, but not limited to the least mean square algorithm (LMS), the variable step-size least mean square (VSLMS) algorithm, the frequency based LMS algorithm, and the partitioned frequency based LMS algorithm.

7. The method as claimed in claim 1, further comprising using the extracted information for positioning the multiple reader head.

8. The method as claimed in claim 1, wherein the multiple reader head comprises a double reader head.

9. The method as claimed in claim 1, wherein the multiple reader head comprises a triple or more reader head.

10. A system for estimating the position error signal (PES) metric for a magnetic storage system, the system comprising:
a multiple reader head configured to be positioned at or near a data track of interest for reading multiple readback tracks from a storage medium of the magnetic storage system using respective readers of the multiple reader head;
an adaptive SMR equalizer configured to equalize the signals from the multiple reader head; and
a processor unit for extracting information from the adaptive SMR equalizer sub-filters as an estimate of the PES metric.

11. The system as claimed in claim 10, wherein processor unit is configured to calculate energies of the respective equalizer sub-filters.

12. The system as claimed in claim 11, wherein the processor unit is further configured to calculate differences in the energies of the respective equalizer sub-filters.

13. The system as claimed in claim 12, wherein the processor unit is further configured to normalize the calculated differences in the energies of the respective equalizer sub-filters.

14. The system as claimed in claim 13, wherein the normalizing comprises dividing the calculated differences in the energies of the respective equalizer sub-filters by the sum of the energies.

15. The system as claimed in claim 10, wherein the adaptive SMR equalizer is based on any of a group of adaptive filtering algorithms including, but not limited to the least mean square algorithm (LMS), the variable step-size least mean square (VSLMS) algorithm, the frequency based LMS algorithm, and the partitioned frequency based LMS algorithm.

16. The system as claimed in claim 10, further comprising servo unit configured to use the extracted information for positioning the multiple reader head.

17. The system as claimed in claim 10, wherein the multiple reader head comprises a double reader head.

18. The system as claimed in claim 10, wherein the multiple reader head comprises a triple or more reader head.
